(19) United States
(12) Patent Application Publication
(10) Pub. No.: US 2025/0129250 A1
(43) Pub. Date: Apr. 24, 2025

(54) ELECTROCONDUCTIVE CARBON BLACK, METHOD FOR PRODUCING ELECTROCONDUCTIVE CARBON BLACK, AND ELECTROCONDUCTIVE MATERIAL

(71) Applicant: TOKAI CARBON CO., LTD., Tokyo (JP)

(72) Inventors: Keisuke Osamura, Tokyo (JP); Kengo Kurisu, Tokyo (JP); Atsushi Hieno, Tokyo (JP); Yuki Akiyama, Tokyo (JP); Masanori Ozawa, Tokyo (JP)

(73) Assignee: TOKAI CARBON CO., LTD., Tokyo (JP)

(21) Appl. No.: 18/712,492

(22) PCT Filed: Oct. 19, 2023
(86) PCT No.: PCT/JP2023/037933

§ 371 Date: May 22, 2024

(30) Foreign Application Priority Data
Dec. 2, 2022 (JP) 2022-193812

(51) Int. Cl. C09C 1/50

(52) U.S. Cl. CPC C09C 1/50; C01P 2002/82; C01P 2006/40

(57) ABSTRACT

To provide an electroconductive carbon black that can exhibit excellent electroconductivity when the electroconductive carbon black is used as a constituent component of various electroconductive materials, an electroconductive carbon black, wherein a nitrogen adsorption specific surface area (N₂SA) of the electroconductive carbon black is 50 to 150 m²/g, a DBP absorption number of the electroconductive carbon black is 205 to 300 mL/100 g, and when an excitation wavelength is 532 nm, a full width at half maximum ΔD of a Raman scattering peak that appears within a range of 1340 to 1360 cm⁻¹ is 100 to 260 cm⁻¹, is used as an electroconductive carbon black.

### TECHNICAL FIELD

The present invention relates to an electroconductive carbon black, a method for producing the electroconductive carbon black, and an electroconductive material.

### BACKGROUND ART

In recent years, with the spread of mobile phones and notebook computers, lithium-ion secondary batteries have attracted attention, and their demand has been increasing year by year. In current lithium-ion secondary batteries, in order to increase the efficiency of battery reaction by increasing an electrode area, positive and negative electrodes, which are usually coated with a paint containing an electrode active material, a binder, an electroconductive material, etc. on a strip of metal foil, are used, and after being rolled together with a separator, the electrodes are stored in a battery can (see Patent Literature 1).

Among them, a lithium transition metal composite oxide and the like are used as the electrode active material in the positive electrode. Because such an electrode active material alone has poor electron conductivity; i.e., electroconductivity, a carbon material such as an electroconductive carbon black in which the structure is highly developed is added as an electroconductive material in order to provide electroconductivity, and is dispersed in a nonaqueous solvent such as N-methyl-2-pyrrolidone together with a binder (binding material), to prepare a slurry (see Patent Literature 2), and this slurry is coated and dried on metal foil, to form a positive electrode.

On the other hand, injection trays, vacuum forming trays, magazines, carrier tapes (embossed carrier tapes), etc. are used as packaging forms for electronic components such as integrated circuits (ICs) and electronic components using ICs. In order to prevent electronic components from being destroyed by static electricity, electroconductive sheets containing electroconductive carbon black dispersed in a resin are laminated and disposed in the packaging containers such as the above products, to reduce the surface specific resistivity.

### CITATION LIST

### Patent Literature

### [Patent Literature 1]

Japanese Patent Laid-Open No. 2003-308845

### [Patent Literature 2]

Japanese Patent Laid-Open No. 2003-157846

### [Patent Literature 3]

Japanese Patent Laid-Open No. 2020-172602

### SUMMARY OF INVENTION

### Technical Problem

The electroconductive carbon black is inexpensive and can exhibit uniform and stable electroconductivity. However, with the recent progress of product development, there is a growing demand for materials that can exhibit better electroconductivity as a blending component of the electroconductive material such as an electrode material and an electroconductive sheet.

Under such circumstances, the present invention is to provide an electroconductive carbon black that can exhibit excellent electroconductivity when the electroconductive carbon black is used as a constituent component of various electroconductive materials, a method for producing the electroconductive carbon black, and an electroconductive material including the electroconductive carbon black.

### Solution to Problem

First, the present applicant proposed carbon black that can prevent exothermic properties and can exhibit more excellent wear resistance when the carbon black is blended to a rubber composition, in which the carbon black falls within a predetermined range of a total active point, the total active point being represented by the product of a full width at half maximum (ΔD) of a Raman scattering peak that appears within a range of 1340 to 1360 cm⁻¹ when the excitation wavelength is 532 nm and a specific surface area (N₂SA) when a nitrogen gas is adsorbed (see Patent Literature 3).

The present inventors conceived use of the above carbon black as an electroconductive carbon black, but found that the above carbon black has high compressive electrical resistivity or volume resistivity and poor electroconductivity when used as a constituent component of various electroconductive materials.

In order to solve the above technical problems, when the present inventors performed further investigations, they found that the above technical problems can be solved by using, as an electroconductive carbon black, carbon black, wherein a nitrogen adsorption specific surface area (N₂SA) of the electroconductive carbon black is 50 to 150 m²/g, a DBP absorption number of the electroconductive carbon black is 205 to 300 mL/100 g, and when an excitation wavelength is 532 nm, a full width at half maximum ΔD of a Raman scattering peak that appears within a range of 1340 to 1360 cm⁻¹ is 100 to 260 cm⁻¹. Then, the present inventors completed the present invention based on this finding.

That is, the present invention is to provide:

(1) An electroconductive carbon black,
wherein a nitrogen adsorption specific surface area (N₂SA) of the electroconductive carbon black is 50 to 150 m²/g,
a DBP absorption number of the electroconductive carbon black is 205 to 300 mL/100 g, and
when an excitation wavelength is 532 nm, a full width at half maximum ΔD of a Raman scattering peak that appears within a range of 1340 to 1360 cm⁻¹ is 100 to 260 cm⁻¹;
   (2) A method for producing the electroconductive carbon black according to (1),
wherein with a reaction furnace in which a fuel combustion zone, a raw material introduction zone, and an additive oil introduction zone are sequentially provided from upstream toward downstream of a gas passage,
an oxygen-containing gas and a fuel are introduced to the fuel combustion zone, and are mixed and combusted to generate a high-temperature combustion gas flow, a stock oil and an oxygen-containing gas are introduced while the high-temperature combustion gas flow is introduced to the raw material introduction zone to perform primary reaction, to generate a primarily reacted product, and an additive oil is introduced to an additive oil introduction zone to perform secondary reaction,
the stock oil and the oxygen-containing gas are introduced so that an amount of oxygen in the oxygen-containing gas introduced to the raw material introduction zone is 0.05 to 0.20 Nm³ per 1 kg of the stock oil.
   (3) An electroconductive material including:
the electroconductive carbon black according to (1).

### Advantageous Effects of Invention

According to the present invention, the present invention is to provide an electroconductive carbon black that can exhibit excellent electroconductivity when the electroconductive carbon black is used as a constituent component of various electroconductive materials, a method for producing the electroconductive carbon black, and an electroconductive material including the electroconductive carbon black.

### BRIEF DESCRIPTION OF DRAWINGS

FIG. 1 is an explanation drawing showing a method for calculating a full width at half maximum ΔD in an electroconductive carbon black according to the present invention.

FIG. 2 is a view showing a measurement example of a Raman spectrum in an electroconductive carbon black according to the present invention.

FIG. 3 is a schematic cross-sectional view showing an embodiment of a reaction furnace used in a method for producing carbon black according to the present invention.

FIG. 4 is graphs of Raman spectra obtained in Examples and Comparative Examples of the present invention.

### DESCRIPTION OF EMBODIMENTS

First, an electroconductive carbon black according to the present invention will be described.

The electroconductive carbon black according to the present invention is characterized by that:
a nitrogen adsorption specific surface area (N₂SA) is 50 to 150 m²/g,
a DBP absorption number of the electroconductive carbon black is 205 to 300 mL/100 g, and
when an excitation wavelength is 532 nm, a full width at half maximum ΔD of a Raman scattering peak that appears within a range of 1340 to 1360 cm⁻¹ is 100 to 260 cm⁻¹.

The nitrogen adsorption specific surface area (N₂SA) of the electroconductive carbon black according to the present invention is 50 to 150 m²/g.

When the nitrogen adsorption specific surface area (N₂SA) of the electroconductive carbon black according to the present invention falls within the above range, the electroconductive carbon black according to the present invention can easily exhibit high electroconductivity when used as a constituent component of various electroconductive materials while homoaggregation of carbon blacks can be prevented.

The nitrogen adsorption specific surface area (N₂SA) of the electroconductive carbon black according to the present invention is preferably 50 to 150 m²/g from the viewpoints of providing high electroconductivity, more preferably 50 to 130 m²/g from the viewpoints of preventing homoaggregation and providing high electroconductivity, and still more preferably 60 to 130 m²/g from the viewpoints of forming electroconductive path and providing high electroconductivity.

The N₂SA is a value representing the specific surface area of carbon black by an adsorption amount (m²/g) of nitrogen molecules per carbon black unit mass, and the N₂SA in the present application documents means a value determined according to JIS K6217-7:2013 “Testing methods of fundamental characteristics of carbon black for rubber industry” (ref., ASTM D6556-16).

The N₂SA/IA of the electroconductive carbon black according to the present invention is preferably 0.85×10³ to 1.10×10³ m²/g.

Here, the N₂SA is a nitrogen adsorption specific surface area (m²/g) of the above carbon black, and the IA is a value obtained by representing a specific surface area of the carbon black by an adsorption amount (mg/g) of iodine molecules per carbon black unit mass in a liquid phase.

Like the N₂SA, the IA is an indicator representing the specific surface area of carbon black, but is also a value that depends on the amount of functional groups on the surface of the carbon black (as the amount of acid functional groups is higher, iodine molecules are less likely to be adsorbed, and its value becomes a value slightly lower than N₂SA).

The N₂SA/IA obtained by dividing the value of N₂SA by the value of IA is an indicator of the surface activity of carbon black, and means that as this N₂SA/IA value is larger, the amount of functional groups on the surface of the carbon black is larger.

As the amount of functional groups on the surface of the carbon black is smaller, n electrons move freely on the surface of carbon black, improving electroconductivity. On the other hand, the amount of the functional groups on the surface is too small, interaction of the carbon black with respect to a rubber or resin is hardly caused, and homoaggregation of carbon blacks is easily caused, easily decreasing electroconductivity.

When the electroconductive carbon black according to the present invention has N₂SA/IA falling within the aforementioned range, excellent electroconductivity can be easily exhibited when it is used as a constituent component of various electroconductive materials while homoaggregation of carbon blacks is prevented.

The N₂SA/IA of the electroconductive carbon black according to the present invention is preferably 0.85×10³ to 1.10×10³ m²/g from the viewpoints of providing high electroconductivity, more preferably 0.85×10³ to 1.05×10³ m²/g from the viewpoints of improving electroconductivity because of free movement of π electrons, and still more preferably 0.90×10³ to 1.05×10³ m²/g from the viewpoints of preventing homoaggregation.

Note that, in the present application documents, the IA means a value determined according to JIS K6217-1997 “Testing methods of fundamental characteristics of carbon black for rubber industry”.

The electroconductive carbon black according to the present invention has a DBP absorption number of 205 to 300 mL/100 g.

When the electroconductive carbon black according to the present invention has a DBP absorption number falling within the aforementioned range, it is possible to easily produce and provide such an electroconductive carbon black that can easily exhibit high electroconductivity when used as a constituent component of various electroconductive materials.

The DBP absorption number of the electroconductive carbon black according to the present invention is 205 mL/100 g or more from the viewpoints of providing high electroconductivity, and more preferably 220 mL/100 g or more from the viewpoints of providing high electroconductivity because of formation of electroconductive path. The DBP absorption number of the electroconductive carbon black according to the present invention is preferably 300 mL/100 g or less, more preferably 250 mL/100 g or less, and still more preferably 236 mL/100 g or less because bulkiness can be prevented to reduce clogging in a carbon black capture system.

The DBP absorption number is a value that represents the structure of carbon black by an absorption number (mL/100 g) of DBP (dibutyl phthalate) relative to 100 g of carbon black.

In the present application documents, the DBP absorption number means a value determined according to JIS K6217-1997 “Testing methods of fundamental characteristics of carbon black for rubber industry”.

The rate of voids between aggregates of carbon black positively correlates to the structure of the carbon black. Therefore, a larger value of the DBP absorption number means that the structure of the carbon black is developed.

Regarding the electroconductive carbon black according to the present invention, a full width at half maximum ΔD of a Raman scattering peak that appears within a range of 1340 to 1360 cm⁻¹ is 100 to 260 cm⁻¹ when an excitation wavelength is 532 nm.

Regarding the electroconductive carbon black according to the present invention, in the case where a full width at half maximum ΔD of a Raman scattering peak that appears within a range of 1340 to 1360 cm⁻¹ falls within the aforementioned range when an excitation wavelength is 532 nm, π electrons move freely on the surface of carbon black, and excellent electroconductivity can be easily exhibited when it is used as a constituent component of various electroconductive materials while homoaggregation of carbon blacks is prevented.

In the electroconductive carbon black according to the present invention, when an excitation wavelength is 532 nm, a full width at half maximum ΔD of a Raman scattering peak that appears within a range of 1340 to 1360 cm⁻¹ is 100 to 260 cm⁻¹ from the viewpoints of providing high electroconductivity, preferably 120 to 260 cm⁻¹ from the viewpoints of preventing homoaggregation, and more preferably 120 to 240 cm⁻¹ from the viewpoints of improving electroconductivity because of free movement of π electrons.

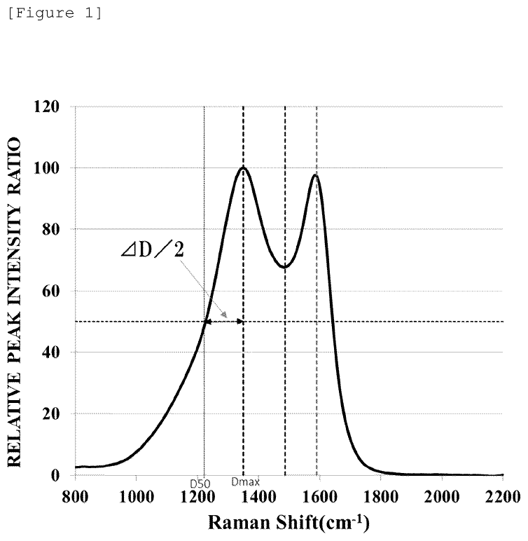

FIG. 1 is a view showing a method for calculating a full width at half maximum (full width at half maximum ΔD) in an electroconductive carbon black according to the present invention (Note that, FIG. 1 is only exemplified to explain a method for calculating the above full width at half maximum (full width at half maximum ΔD)).

As shown in FIG. 1, in the carbon black according to the present invention, a peak is detected, the peak having a peak top within a range of 1340 to 1360 cm⁻¹ (1350±10 cm⁻¹) in a Raman spectrum obtained by measuring the carbon black at excitation wavelength (532 nm) by the laser Raman spectroscopy.

When the measurement wavelength at the position of the above peak top is Dmax (cm⁻¹) and, in the obtained spectrum, a detection position at a side of a low wavelength (low Raman shift) having half of the detection intensity of the peak intensity at the above Dmax is D50 (cm⁻¹), a value calculated by the following equation is considered as the full width at half maximum ΔD (cm⁻¹) in the present application.

$$Δ D = ( D max - D 50 ) \times 2$$

In the present application documents, the full width at half maximum ΔD (cm⁻¹) means a value calculated from the Raman spectrum, which is obtained by performing measurement under the following measurement condition (of Procedure 1), followed by performing data processing (of Procedure 2).

(Procedure 1) As a laser Raman spectroscopic device, HR-800 available from HORIBA, Ltd. is used. Several particles of a sample of carbon black as a measurement sample are placed on a slide glass, and is rubbed several times with a spatula, to make the surface flat. The flat surface is measured under the following measurement conditions.
YAG laser (excitation wavelength): 532 nm
Number of lines: 600 gr/mm
Filter: D0.6
Magnification of objective lens: 100 folds
Exposure time: 150 seconds
Cumulative number: two times

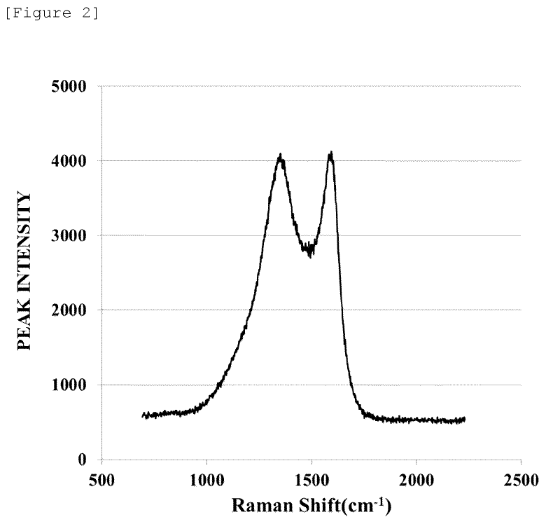

The spectrum example obtained at this time is shown in FIG. 2.

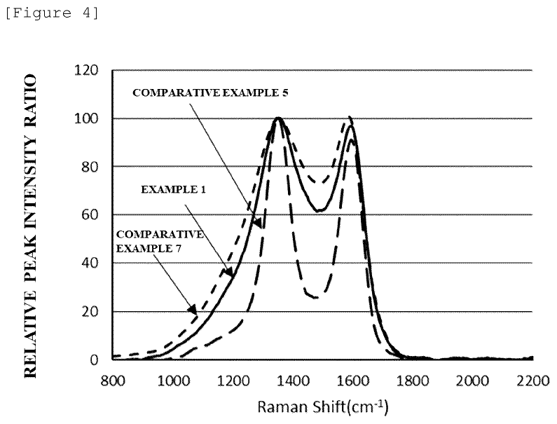

(Procedure 2) The signal intensity of the obtained spectrum at the measurement wavelength (Raman Shift) 2100 cm⁻¹ is defined as 0. Among the data points constituting the spectrum, the average value is determined for each of the 39 adjacent points, and then the smoothing processing is performed to obtain a spectral curve that connects each of the average values. Next, in order to facilitate comparison between samples, the peak top intensity observed in the measurement wavelength range of 1350±10 cm⁻¹ is set to 100. An example of the Raman spectrum obtained at this time is a Raman spectrum as shown in FIG. 1 or FIG. 4. Here, the horizontal axis of the graph is Raman shift (cm⁻¹), and the vertical axis is the peak intensity ratio (relative peak intensity ratio) with the peak intensity at Dmax being defined as 100.

In the Raman spectrum, a peak having the peak top within a range of 1340 to 1360 cm⁻¹ (1350±10 cm⁻¹) corresponds to a peak in D band of the Raman spectrum.

According to the studies performed by the present inventors, the full width at half maximum ΔD of the peak of the D band represents a degree of randomness of the crystal structure on the surface of the carbon black; i.e., crystallinity. A higher value of the full width at half maximum ΔD of the peak of the D band means that the crystal structure is more disordered (crystallinity is low).

It is believed that when the crystallinity is high, the edge on the surface of carbon black is small, and π electrons on the surface of the carbon black move freely, thus improving electroconductivity. On the other hand, it is believed that when the crystallinity is too high, the number of portions where functional groups are formed on the surface of the carbon black (active point) is small, interaction of the carbon black with respect to a rubber or resin is hardly caused, the homoaggregation of carbon blacks is easily caused, and electroconductivity is decreased.

Therefore, in the electroconductive carbon black according to the present invention, it is believed that controlling the full width at half maximum ΔD within a predetermined range makes it easy to allow π electrons to move freely to thereby improve electroconductivity while the homoaggregation of carbon blacks is prevented.

As a method for producing the electroconductive carbon black according to the present invention, a method for producing electroconductive carbon black according to the present invention described below can be exemplified.

According to the present invention, it is possible to provide an electroconductive carbon black that can exhibit excellent electroconductivity when used as a constituent component of various electroconductive materials.

Next, the method for producing electroconductive carbon black according to the present invention will be described.

A method for producing the electroconductive carbon black according to the present invention is a method for producing the above described electroconductive carbon black according to the present invention,
wherein with a reaction furnace in which a fuel combustion zone, a raw material introduction zone, and an additive oil introduction zone are sequentially provided from upstream toward downstream of a gas passage,
an oxygen-containing gas and a fuel are introduced to the fuel combustion zone, and are mixed and combusted to generate a high-temperature combustion gas flow, a stock oil and an oxygen-containing gas are introduced while the high-temperature combustion gas flow is introduced to the raw material introduction zone to perform primary reaction, to generate a primarily reacted product, and an additive oil is introduced to an additive oil introduction zone to perform secondary reaction,
the stock oil and the oxygen-containing gas are introduced so that an amount of oxygen in the oxygen-containing gas introduced to the raw material introduction zone is 0.05 to 0.20 Nm³ per 1 kg of the stock oil.

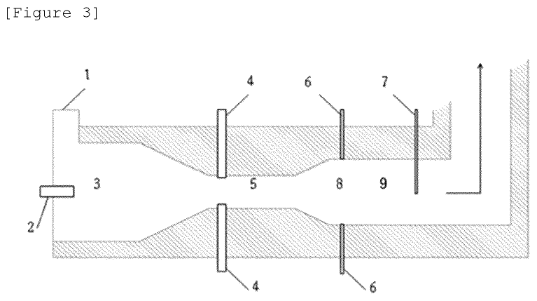

In this case, a reaction furnace, in which a fuel combustion zone, a raw material introduction zone, and an additive oil introduction zone are sequentially provided from upstream toward downstream of a gas passage, is used. Examples of the reaction furnace include the cylindrical reaction furnace having a wide diameter as schematically shown in FIG. 3.

Hereinafter, the method for producing electroconductive carbon black according to the present invention will be appropriately described by using the reaction furnace shown in FIG. 3 as an example.

In the reaction furnace shown in FIG. 3, a fuel combustion zone 3, a raw material introduction zone 5, an additive oil introduction zone 8, and a secondary reaction zone 9, which are in communication with each other from upstream toward downstream of a gas passage formed in the furnace, are sequentially provided.

That is, in the reaction furnace shown in FIG. 3, the fuel combustion zone 3 includes an oxygen-containing gas introduction port 1 configured to introduce an oxygen-containing gas such as air from a direction perpendicular to the direction of the furnace axis and a burner for combustion 2 configured to supply fuel to the direction of the furnace axis. A raw material introduction and primary reaction zone 5 includes a stock oil introduction nozzle 4 configured to supply stock oil from a direction perpendicular to the direction of the furnace axis, and is provided in communication with the fuel combustion zone 3 in a coaxial manner. Moreover, the additive oil introduction zone 8 includes an additive oil introduction nozzle 6 configured to supply an additive oil from a direction perpendicular to the direction of the furnace axis, and is provided in communication with the raw material introduction zone 5 in a coaxial manner. The secondary reaction zone 9 is provided in communication with the additive oil introduction zone 8 in a coaxial manner. The reaction furnace shown in FIG. 3 is provided with a reaction stop zone that is in communication with the secondary reaction zone 9 in a coaxial manner. The reaction stop zone is provided with a coolant introduction nozzle 7 configured to spray a coolant from a direction perpendicular to the direction of the furnace axis.

The reaction furnace shown in FIG. 3 has a drum-like shape in which the tube becomes narrow from the fuel combustion zone 3 toward the raw material introduction zone 5 and the tube is widened from the raw material introduction zone 5 toward the additive oil introduction zone 8. However, the shape of the reaction furnace is not limited to such a shape and can have various shapes.

In the method for producing the electroconductive carbon black according to the present invention, an oxygen-containing gas and fuel are introduced into the fuel combustion zone 3 and are mixed and combusted to generate a high-temperature combustion gas flow.

Examples of the oxygen-containing gas include gases such as oxygen, air, and mixtures thereof. Examples of the fuel include hydrogen, carbon monoxide, natural gas, petroleum gas, FCC residual oil, petroleum-based liquid fuels such as heavy oil, and coal-based liquid fuels such as creosote oil.

Examples of the fuel as a source of generation of the high-temperature combustion gas include the same as those that can generate the aforementioned high-temperature combustion gas.

The amount of the supplied oxygen-containing gas in the fuel combustion zone 3 is preferably 2000 Nm³/h to 5500 Nm³/h, more preferably 2500 Nm³/h to 5000 Nm³/h, and still more preferably 3000 Nm³/h to 4500 Nm³/h. When the amount of the supplied gas is adjusted as described above, the flow of the gas is stable in the generation furnace, and the electroconductive carbon black according to the present invention can be easily produced.

The amount of the supplied fuel in the fuel combustion zone 3 is preferably 50 kg/h to 400 kg/h, more preferably 100 kg/h to 350 kg/h, and still more preferably 150 kg/h to 300 kg/h. When the amount of the supplied fuel is adjusted as described above, the amount of the introduced heat is stable, and the electroconductive carbon black according to the present invention can be easily produced.

In the fuel combustion zone 3, for example, if the fuel is supplied while an oxygen-containing gas that is pre-heated to 400° C. to 600° C. is supplied, both the fuel and the oxygen-containing gas can be mixed and combusted to generate a high-temperature combustion gas flow.

In the method for producing the carbon black according to the present invention, while the high-temperature combustion gas flow is introduced to the raw material introduction zone 5, stock oil is introduced from the stock oil introduction nozzle 4 to the raw material introduction zone 5.

Examples of the stock oil supplied to the raw material introduction zone 5 include one or more selected from: aromatic hydrocarbons such as cyclohexane, benzene, toluene, xylene, naphthalene, and anthracene; coal-based hydrocarbons such as creosote oil and carboxylic acid oil; petroleum-based heavy oils such as ethylene bottom oil (ethylene heavy end oil) and FCC residual oil; acetylene-based unsaturated hydrocarbons; ethylene-based hydrocarbons; and aliphatic saturated hydrocarbons such as pentane and hexane.

In the method for producing the carbon black according to the present invention, the stock oil may be a mixture obtained by mixing two or more kind of hydrocarbons described above.

In the method for producing the carbon black according to the present invention, while the high-temperature combustion gas flow is introduced to the raw material introduction zone 5, the oxygen-containing gas is introduced to the raw material introduction zone 5 together with the stock oil.

Examples of the oxygen-containing gas introduced to the raw material introduction zone 5 together with the stock oil can include gases such as oxygen, air, or mixture thereof.

The oxygen-containing gas introduced to the raw material introduction zone 5 together with the stock oil may be introduced from the stock oil introduction nozzle 4 together with the stock oil, or may be separately introduced from an oxygen-containing gas introduction nozzle (not shown) that is separately provided from the stock oil introduction nozzle 4.

When the oxygen-containing gas is introduced together with the stock oil from the stock oil introduction nozzle 4 to the raw material introduction zone 5, for example, use of a two-fluid nozzle as the stock oil introduction nozzle 4 makes it possible to introduce the stock oil and the oxygen-containing gas.

When the oxygen-containing gas is introduced separately from the stock oil from the oxygen-containing gas introduction nozzle (not illustrated) while the stock oil is introduced from the stock oil introduction nozzle 4 to the raw material introduction zone 5, for example, use of a one-fluid nozzle as the stock oil introduction nozzle 4 and the oxygen-containing gas introduction nozzle (not shown) makes it possible to introduce the stock oil and the oxygen-containing gas.

In the method for producing the electroconductive carbon black according to the present invention, when the oxygen-containing gas is introduced together with the stock oil to the raw material introduction zone while the high-temperature combustion gas flow is introduced to the raw material introduction zone, a high-temperature region is locally formed in the raw material introduction zone. Then, when primary reaction of the stock oil is performed in the raw material introduction zone in which the high-temperature region is locally formed, the DBP absorption number of the obtained electroconductive carbon black can be increased and the full width at half maximum ΔD of the Raman scattering peak that appears within the range of 1340 to 1360 cm⁻¹ when the excitation wavelength is 532 nm can be decreased, to thereby easily produce the electroconductive carbon black having the respective physical properties controlled within a desired range, compared to a case where the oxygen-containing gas is not introduced to the raw material introduction zone.

The amount of the stock oil introduced to the raw material introduction zone 5 is not particularly limited, but is preferably 100 kg/h to 3000 kg/h, more preferably 150 kg/h to 2500 kg/h, and still more preferably 200 kg/h to 2000 kg/h. When the amount of the introduced stock oil falls within the above range, the nitrogen adsorption specific surface area of the obtained electroconductive carbon black can be controlled within a desired range.

The amount of the oxygen-containing gas introduced to the raw material introduction zone 5 is not particularly limited, and is preferably 5 Nm³/h to 600 Nm³/h, more preferably 8 Nm³/h to 500 Nm³/h, and still more preferably 10 Nm³/h to 400 Nm³/h.

When the amount of the oxygen-containing gas introduced to the raw material introduction zone 5 falls within the above range, a local high-temperature region is easily formed in the raw material introduction zone 5, and it is possible to easily produce the electroconductive carbon black having the DBP absorption number and the full width at half maximum ΔD of the Raman scattering peak controlled within the desired range.

In the method for producing the electroconductive carbon black according to the present invention, as the stock oil and the oxygen-containing gas introduced to the raw material introduction zone, the stock oil and the oxygen-containing gas are introduced so that the amount of oxygen in the oxygen-containing gas is 0.05 Nm³ to 0.20 Nm³ per 1 kg of the stock oil.

In the method for producing the electroconductive carbon black according to the present invention, when the rate of the introduced oxygen-containing gas falls within the above range, it is possible to easily produce the electroconductive carbon black in which the full width at half maximum ΔD of the Raman scattering peak that appears within the range of 1340 to 1360 cm⁻¹ when the excitation wavelength is 532 nm is controlled within a predetermined range.

In the method for producing the electroconductive carbon black according to the present invention, the amount of oxygen in the oxygen-containing gas is preferably 0.05 Nm³ to 0.20 Nm³ per 1 kg of the stock oil from the viewpoints of forming a high-temperature region, more preferably 0.07 Nm³ or more per 1 kg of the stock oil from the viewpoints of controlling the DBP absorption number, and still more preferably 0.15 Nm³ or less per 1 kg of the stock oil from the viewpoints of controlling the full width at half maximum ΔD of the Raman scattering peak.

In the method for producing the electroconductive carbon black according to the present invention, when the stock oil and the oxygen-containing gas are introduced to the raw material introduction zone to perform primary reaction, the stock oil and the oxygen-containing gas are preferably introduced to the raw material introduction zone so that the reaction temperature is 1300° C. or more, the stock oil and the oxygen-containing gas are more preferably introduced to the raw material introduction zone so that the reaction temperature is 1500° C. or more, and the stock oil and the oxygen-containing gas are introduced to the raw material introduction zone so that the reaction temperature is 1800° C. or less. As a result, easy production can be achieved. When the reaction temperature falls within the above range, the DBP absorption number and the full width at half maximum ΔD of the Raman scattering peak can be controlled within the desired ranges.

When the reaction temperature (reaction temperature at the time of primary reaction of the stock oil) in the raw material introduction zone is controlled so as to satisfy the above temperature, it is possible to easily produce electroconductive carbon black in which the DBP absorption number or the full width at half maximum ΔD of the Raman scattering peak is controlled within a desired range.

In the method for producing the electroconductive carbon black according to the present invention, the stock oil is introduced to the raw material introduction and primary reaction zone 5 to perform primary reaction, and then an additive oil is introduced to the additive oil introduction zone 8 to perform secondary reaction.

As the above additive oil, a hydrocarbon oil is preferable. Examples of the hydrocarbon oil include: one or more selected from aromatic hydrocarbons such as cyclohexane, benzene, toluene, xylene, naphthalene, and anthracene; acetylene-based unsaturated hydrocarbons; ethylene-based hydrocarbon; and aliphatic saturated hydrocarbons such as pentane and hexane.

In the method for producing the electroconductive carbon black according to the present invention, the secondary reaction is performed so that the addition amount of the additive oil is 0.20 to 0.80 times the mass of the stock oil relative to the primarily reacted product, the secondary reaction is preferably performed so that the addition amount of the additive oil is 0.21 to 0.75 times the mass of the stock oil in order to ensure stable reactivity, and the secondary reaction is more preferably performed so that the addition amount of the additive oil is 0.22 to 0.70 times the mass of the stock oil in order to ensure stable reactivity and high yield.

Specifically, the amount of the additive oil introduced in the additive oil introduction zone is preferably 20 to 2400 kg/h, more preferably 30 to 2000 kg/h, and still more preferably 40 to 1600 kg/h.

In the method for producing the carbon black according to the present invention, when the addition amount of the additive oil falls within the above range, it is possible to produce the electroconductive carbon black, in which N₂SA/IA is controlled within the desired range, with a high yield.

In the method for producing the electroconductive carbon black according to the present invention, when the reaction furnace shown in FIG. 3 is used, after the primary reaction is performed in the raw material introduction zone 5, the additive oil is introduced in the additive oil introduction zone 8, and is introduced in the additive oil introduction zone 8 or the secondary reaction zone 9, to perform secondary reaction. As a result, a target electroconductive carbon black can be easily prepared.

In the method for producing the electroconductive carbon black according to the present invention, a reaction furnace without the secondary reaction zone 9 can be used to perform secondary reaction only in the additive oil introduction zone 8.

In the reaction furnace shown in FIG. 3, carbon black-containing gas is introduced to the reaction stop zone, and a coolant is sprayed.

Examples of the coolant include water. Spraying the coolant cools carbon black particles that are floated and suspended in the high-temperature combustion gas. The coolant can be sprayed, for example, from the coolant introduction nozzle 7 shown in FIG. 3.

Next, the cooled carbon black particles are separated and captured by a capture system (separating and capturing device) such as a cyclone or a bag filter, via, for example, a flue, and thus the target electroconductive carbon black can be collected.

In the method for producing the electroconductive carbon black according to the present invention, when the additive oil is introduced to the primarily reacted product, followed by reaction, it is possible to easily produce the electroconductive carbon black in which edges as active points having a predetermined number are formed on the surface.

Details of the electroconductive carbon black obtained by the production method according to the present invention are as described above.

According to the present invention, it is possible to provide a method for producing electroconductive carbon black that can easily produce the electroconductive carbon black that can exhibit excellent electroconductivity when used as a constituent component of various electroconductive materials.

Next, the electroconductive material according to the present invention will be described.

The electroconductive material according to the present invention includes the electroconductive carbon black according to the present invention.

The electroconductive material according to the present invention is not particularly limited as long as it includes the electroconductive carbon black according to the present invention described above.

Examples of the electroconductive material according to the present invention include electrode materials such as a positive electrode material of a lithium-ion secondary battery and various electroconductive sheets.

According to the present invention, it is possible to provide an electroconductive material that includes the electroconductive carbon black according to the present invention and can exhibit excellent electroconductivity.

Next, the present invention will be described in detail by way of Examples. However, this is merely an example and do not limit the present invention.

### EXAMPLES

### Example 1

A reaction furnace having a substantially cylindrical shape as shown in FIG. 3 was used to produce carbon black.

A reaction furnace as shown in FIG. 3 is provided sequentially with the fuel combustion zone 3, the raw material introduction zone 5, the additive oil introduction zone 8, the secondary reaction zone 9, and the reaction stop zone, which are in communication with each other from upstream toward downstream of a gas passage formed in the furnace.

In the reaction furnace shown in FIG. 3, the fuel combustion zone 3 includes an oxygen-containing gas introduction port 1 configured to introduce an oxygen-containing gas such as air from a direction perpendicular to the direction of the furnace axis and a burner for combustion 2 configured to supply fuel to the direction of the furnace axis. In addition, the raw material introduction zone 5 includes, as the stock oil introduction nozzle 4, a two-fluid nozzle configured to supply stock oil and oxygen from a direction perpendicular to the direction of the furnace axis and is in communication with the fuel combustion zone 3 in a coaxial manner.

The additive oil introduction zone 8 includes a one-fluid nozzle that is the additive oil introduction nozzle 6 configured to supply additive oil from a direction perpendicular to the direction of the furnace axis, and is in communication with the raw material introduction and primary reaction zone 5 in a coaxial manner. Moreover, the secondary reaction zone 9 is provided in communication with the additive oil introduction zone 8 in a coaxial manner. The reaction stop zone includes the coolant introduction nozzle 7 (water cooling quench). The position of the coolant introduction nozzle 7 can be changed in the vertical direction of the figure. The coolant introduction nozzle 7 is configured to supply a cooling water from a direction perpendicular to the direction of the furnace axis and is provided in communication with the secondary reaction zone 9 in a coaxial manner.

As shown in FIG. 3, the reaction furnace has a drum-like drawing shape in which, before and after the raw material introduction zone 5, the tube gradually becomes narrow from the fuel combustion zone 3 toward the raw material introduction zone 5 and the tube is widened from the raw material introduction zone 5 toward the additive oil introduction zone 8 in a tapered manner.

In the fuel combustion zone 3, air (the rate of oxygen contained: 21% by volume) that was pre-heated to 500° C. was supplied at 4000 Nm³/h from the oxygen-containing gas introduction port 1, and FCC residual oil (petroleum-based residual oil) as a fuel oil was sprayed and supplied from the burner for combustion 2 at 200 kg/h, followed by mixing and combusting. Then, a high-temperature combustion gas flow that is in communication with the direction of the furnace axis was formed.

While the high-temperature combustion gas flow was introduced to the raw material introduction zone 5, the FCC residual oil as the stock oil was supplied at 1500 kg/h and oxygen was supplied at 100 Nm³/h from a two-fluid nozzle as the stock oil introduction nozzle 4. Then, cyclohexane was supplied at 370 kg/h from the additive oil introduction nozzle 6 in the additive oil introduction zone 8, and the primary reaction was performed at a reaction temperature of 1600° C., to generate an electroconductive carbon black-containing gas.

At this time, the introduction of the stock oil and oxygen to the raw material introduction zone 5 corresponds to the introduction of stock oil and oxygen in an amount of oxygen of 0.07 Nm³ per 1 kg of the stock oil.

The electroconductive carbon black-containing gas generated via the raw material introduction zone 5 and the additive oil introduction zone 8 was introduced to the secondary reaction zone 9 to allow it to sufficiently react. Then, the electroconductive carbon black-containing gas was introduced to the reaction stop zone, and a cooling water was sprayed from the coolant introduction nozzle 7. The cooled carbon black particles were captured by a separating and capturing device (not illustrated) via, for example, a flue, and a target electroconductive carbon black was collected.

The nitrogen adsorption specific surface area N₂SA (m²/g), the DBP absorption number (mL/100 g), and the IA (mg/g) of the obtained electroconductive carbon black were measured. The obtained results are shown in Table 2 together with N₂SA/IA (×10³ m²/g).

In addition, in the obtained electroconductive carbon black, when the excitation wavelength was 532 nm, the full width at half maximum ΔD of the Raman scattering peak that appears within the range of 1340 to 1360 cm⁻¹ was measured. The Raman spectrum obtained at this time is shown in FIG. 4, and the full width at half maximum ΔD of the Raman scattering peak is shown in Table 2.

### Example 2 to Example 7 and Comparative Example 1 to Comparative Example 9

An electroconductive carbon black was prepared in the same manner as in Example 1 except that the amount of supplied stock oil (kg/h), the amount of supplied oxygen (kg/h) supplied from the stock oil introduction nozzle 4 (two-fluid nozzle) to the raw material introduction zone, and the amount of oxygen (Nm³) per 1 kg of the stock oil were each changed as described in Table 1.

The nitrogen adsorption specific surface area N₂SA (m²/g), the DBP absorption number (mL/100 g), and the IA (mg/g) in each of the obtained electroconductive carbon blacks were measured. The obtained results are shown in Table 2 together with N₂SA/IA (×10³ m²/g).

In each of the obtained carbon blacks, the full width at half maximum ΔD of the Raman scattering peak that appears within the range of 1340 to 1360 cm⁻¹ when the excitation wavelength is 532 nm is shown in Table 2.

In the electroconductive carbon blacks obtained in Comparative Example 5 and Comparative Example 7, the Raman spectra, which were obtained by measuring the full width at half maximum ΔD of the Raman scattering peak that appears within the range of 1340 to 1360 cm⁻¹ when the excitation wavelength is 532 nm, are shown in FIG. 4.

Note that, the electroconductive carbon blacks obtained in Comparative Example 8 and Comparative Example 9 correspond to the carbon black described in Patent Literature 3.

TABLE 1

| | | | Amount of | Amount of |
|---|---|---|---|---|
| | Amount of | Amount of | oxygen per | additive oil |
| | supplied | supplied | 1 kg of | relative to |
| | stock oil | oxygen | stock oil | stock oil |
| | (kg/h) | (Nm³/h) | (Nm³) | (mass ratio) |
| Example 1 | 1500 | 100 | 0.07 | 0.25 |
| Example 2 | 1200 | 140 | 0.12 | 0.31 |
| Example 3 | 1500 | 70 | 0.05 | 0.25 |
| Example 4 | 1500 | 160 | 0.11 | 0.25 |
| Example 5 | 1700 | 250 | 0.15 | 0.22 |
| Example 6 | 1000 | 80 | 0.08 | 0.37 |
| Example 7 | 1000 | 200 | 0.20 | 0.37 |
| Comparative | 1500 | 0 | 0.00 | 0.25 |
| Example 1 | | | | |
| Comparative | 600 | 0 | 0.00 | 0.62 |
| Example 2 | | | | |
| Comparative | 1300 | 0 | 0.00 | 0.28 |
| Example 3 | | | | |
| Comparative | 1000 | 0 | 0.00 | 0.37 |
| Example 4 | | | | |
| Comparative | 1000 | 250 | 0.25 | 0.37 |
| Example 5 | | | | |
| Comparative | 1400 | 0 | 0.00 | 0.26 |
| Example 6 | | | | |
| Comparative | 1800 | 0 | 0.00 | 0.21 |
| Example 7 | | | | |
| Comparative | 550 | 0 | 0.00 | 0.67 |
| Example 8 | | | | |
| Comparative | 900 | 0 | 0.00 | 0.41 |
| Example 9 | | | | |

Amount of supplied air 4000 (Nm³/h)
Amount of supplied fuel 200 (kg/h)
Amount of supplied additive oil 370 (kg/h)

TABLE 2

| | | DBP | | | |
|---|---|---|---|---|---|
| | | absorption | | | |
| | N₂SA | number | ΔD | IA | N₂SA/IA |
| | (m²/g) | (mL/100 g) | (cm⁻¹) | (mg/g) | (×10³m²/g) |
| Example 1 | 67 | 257 | 193 | 72 | 0.93 |
| Example 2 | 102 | 206 | 186 | 112 | 0.91 |
| Example 3 | 52 | 212 | 257 | 48 | 1.08 |
| Example 4 | 60 | 295 | 218 | 56 | 1.07 |
| Example 5 | 57 | 242 | 110 | 57 | 1.00 |
| Example 6 | 136 | 234 | 240 | 140 | 0.97 |
| Example 7 | 145 | 277 | 107 | 166 | 0.87 |
| Comparative | 44 | 270 | 185 | 53 | 0.83 |
| Example 1 | | | | | |
| Comparative | 166 | 234 | 223 | 145 | 1.14 |
| Example 2 | | | | | |
| Comparative | 73 | 189 | 204 | 77 | 0.95 |
| Example 3 | | | | | |
| Comparative | 96 | 252 | 265 | 95 | 1.01 |
| Example 4 | | | | | |
| Comparative | 118 | 226 | 92 | 125 | 0.94 |
| Example 5 | | | | | |
| Comparative | 55 | 158 | 271 | 42 | 1.31 |
| Example 6 | | | | | |
| Comparative | 30 | 172 | 266 | 24 | 1.25 |
| Example 7 | | | | | |
| Comparative | 168 | 195 | 232 | 150 | 1.12 |
| Example 8 | | | | | |
| Comparative | 115 | 192 | 210 | 110 | 1.05 |
| Example 9 | | | | | |

### <Evaluation 1 (Preparation of Positive Electrode Material)>

### 1. Preparation of Positive Electrode Material

Each of the electroconductive carbon blacks obtained in Example 1 to Example 7 and Comparative Example 1 to Comparative Example 9 was used to prepare a positive electrode material by the following method.

The electroconductive carbon black (5% by mass) and a commercially available lithium nickel cobalt manganese oxide (NCM811 (made in China)) powder (95% by mass) were mixed using a shaker in a simple manner, to prepare an evaluation sample.

### 2. Evaluation of Electroconductivity (Measurement of Compressive Electrical Resistivity)

Each of the positive electrode materials obtained in 1. was used to prepare a positive electrode material in the following method. Then, the compressive electrical resistivity was measured according to JISK1469, to evaluate electroconductivity.

Using an insulating alumina sleeve (outer diameter of 12 mm, inner diameter of 8 mm, length of 50 mm) and a pedestal jig for fixing the alumina sleeve, 2 g of a positive electrode material was filled into the sleeve. The filled sample was compressed by a piston with a force of 1000 N, a current was allowed to flow between the samples at a known constant current I (A), the voltage drop E (V) at that time was measured, and the electrical resistance R was determined by dividing E by I. The cross-sectional area S (cm²) of the filled sample is the area of a circle with a diameter of 0.8 cm. Regarding the height h (cm) of the sample at the time of measurement, the position of the displacement meter at the top of the piston after compression when no sample is present is considered as the home position, and the sample is measured by using, as the sample height, the position of the displacement meter at the top of the piston after compression. The compressive electrical resistivity ρ (Ω·cm) was determined by the following equation.

$$ρ = S / h \times R$$

Results are shown in Table 3.

### <Evaluation 2 (Preparation of Resin-Containing Electroconductive Sheet)>

### 1. Preparation of Resin-Containing Electroconductive Sheet

A resin-containing electroconductive sheet was produced by the following method using each of the electroconductive carbon blacks obtained in Example 1 to Example 7 and Comparative Example 1 to Comparative Example 9.

Each of the electroconductive carbon blacks obtained in Examples and Comparative Examples (40 parts by mass) was added to ethylene-vinyl acetate copolymer (100 parts by mass), and was kneaded at 120° C. for 10 minutes using a closed-type mixer (model: 10M100 model) with the number of rotations of the blade being set to 50 rpm. Then, vulcanization was performed at 105° C. for 15 minutes using a pressurized heat press machine to obtain a resin-containing sheet.

### 2. Evaluation of Electroconductivity (Measurement of Volume Resistivity)

Using each of the resin-containing electroconductive sheets obtained in 1., the volume resistivity VR (Ω·cm) was measured according to JIS K 6911 (general testing methods for thermosetting plastics) to evaluate the electroconductivity. Specifically, the volume resistivity VR (Ω·cm) was determined under the following conditions.

### (Volume Resistivity)

Measurement device: digital ultra-high resistance/micro current meter available from ADCMT
Measurement method: double-ring electrode method
Guard electrode: outer diameter of 80 mm, inner diameter of 70 mm
Diameter of main electrode: 50 mm
External dimension of sample (length×width): 100 mm×100 mm
Sample thickness: 2 mm
Applied voltage: 1 V
Detection current range: 200 pA to 20 mA

The logarithm of the measured volume resistivity VR (LogVR) is shown in Table 3.

### <Evaluation 3 (Production of Rubber-Containing Electroconductive Sheet)>

### 1. Production of Rubber-Containing Electroconductive Sheet

A rubber-containing electroconductive sheet was produced by the following method using each of the electroconductive carbon blacks obtained in Example 1 to Example 7 and Comparative Example 1 to Comparative Example 9.

Each of the electroconductive carbon blacks obtained in Examples and Comparative Examples (30 parts by mass) and sulfur (1.5 parts by mass) were added to EPDM rubber (100 parts by mass), and were kneaded at 160° C. for 5 minutes using a closed-type mixer (MIXTRON BB-2, available from Kobe Steel, Ltd.) with the number of rotations of the blade being set to 85 rpm. Then, vulcanization was performed at 150° C. for 40 minutes using a pressurized heat press machine to obtain a rubber-containing sheet.

### 2. Evaluation of Electroconductivity (Measurement of Volume Resistivity)

Using each of the rubber-containing electroconductive sheets obtained in 1., the volume resistivity VR (Ω·cm) was measured according to JIS K6271-1:2015 (Vulcanized rubber and thermoplastic rubber—Determination of electrical resistivity). Specifically, the volume resistivity VR (Ω·cm) was determined under the following conditions.

### (Volume Resistivity)

Measurement device: digital ultra-high resistance/micro current meter available from ADCMT
Measurement method: double-ring electrode method
Guard electrode: outer diameter of 80 mm, inner diameter of 70 mm
Diameter of main electrode: 50 mm
External dimension of sample (length×width): 100 mm×100 mm
Sample thickness: 2 mm
Applied voltage: 1 V
Detection current range: 200 pA to 20 mA

The logarithm of the measured volume resistivity VR (LogVR) is shown in Table 3.

TABLE 3

| | Evaluation 1 | Evaluation 2 | Evaluation 3 |
|---|---|---|---|
| | Compressive | Logarithm | Logarithm |
| | electrical | of volume | of volume |
| | resistivity | resistivity VR | resistivity VR |
| | (Ω · cm) | (LogVR) | (LogVR) |
| Example 1 | 3.8 | 4.8 | 4.1 |
| Example 2 | 4.8 | 5.2 | 4.9 |
| Example 3 | 5.0 | 5.7 | 5.3 |
| Example 4 | 3.2 | 4.5 | 3.8 |
| Example 5 | 3.5 | 5.3 | 5.0 |
| Example 6 | 4.1 | 4.9 | 4.4 |
| Example 7 | 3.0 | 4.7 | 5.1 |
| Comparative | 7.0 | 6.0 | 7.1 |
| Example 1 | | | |
| Comparative | 11.0 | 7.2 | 8.0 |
| Example 2 | | | |
| Comparative | 15.0 | 8.4 | 9.9 |
| Example 3 | | | |
| Comparative | 10.2 | 7.1 | 8.2 |
| Example 4 | | | |
| Comparative | 14.7 | 8.0 | 11.0 |
| Example 5 | | | |
| Comparative | 19.0 | 8.5 | 10.7 |
| Example 6 | | | |
| Comparative | 21.0 | 8.8 | 11.5 |
| Example 7 | | | |
| Comparative | 11.5 | 7.6 | 8.1 |
| Example 8 | | | |
| Comparative | 14.0 | 7.7 | 9.0 |
| Example 9 | | | |

From the results of Table 2 and Table 3, the nitrogen adsorption specific surface area (N₂SA), the DBP absorption number, and the full width at half maximum ΔD of the Raman scattering peak of each of the electroconductive carbon blacks according to the present invention obtained in Example 1 to Example 7 fall within each of the predetermined ranges. Therefore, it is found that the electroconductive carbon black according to the present invention has low compressive electrical resistivity or volume resistivity when used as a constituent component of various electroconductive materials, and can exhibit excellent electroconductivity.

On the other hand, from the results of Table 2 and Table 3, the nitrogen adsorption specific surface area (N₂SA), the DBP absorption number, and the full width at half maximum ΔD of the Raman scattering peak of each of the electroconductive carbon blacks obtained in Comparative Example 1 to Comparative Example 9 do not fall within each of the predetermined ranges. Therefore, it is found that such electroconductive carbon blacks have high compressive electrical resistivity or volume resistivity when used as a constituent component of various electroconductive materials, and have poor electroconductivity.

### INDUSTRIAL APPLICABILITY

According to the present invention, it is possible to provide an electroconductive carbon black that can exhibit excellent electroconductivity when used as a constituent component of various electroconductive materials, a method for producing the electroconductive carbon black, and an electroconductive material.

### REFERENCE SIGNS LIST

1 oxygen-containing gas introduction port
2 burner for combustion
3 fuel combustion zone
4 stock oil introduction nozzle
5 raw material introduction zone
6 additive oil introduction nozzle
7 coolant introduction nozzle
8 additive oil introduction zone
9 secondary reaction zone

1. An electroconductive carbon black,
wherein a nitrogen adsorption specific surface area (N₂SA) of the electroconductive carbon black is 50 to 150 m²/g,
a DBP absorption number of the electroconductive carbon black is 205 to 300 mL/100 g, and
when an excitation wavelength is 532 nm, a full width at half maximum ΔD of a Raman scattering peak that appears within a range of 1340 to 1360 cm⁻¹ is 100 to 260 cm⁻¹.

2. A method for producing the electroconductive carbon black according to claim 1,
wherein with a reaction furnace in which a fuel combustion zone, a raw material introduction zone, and an additive oil introduction zone are sequentially provided from upstream toward downstream of a gas passage,
an oxygen-containing gas and a fuel are introduced to the fuel combustion zone, and are mixed and combusted to generate a high-temperature combustion gas flow, a stock oil and an oxygen-containing gas are introduced while the high-temperature combustion gas flow is introduced to the raw material introduction zone to perform primary reaction, to generate a primarily reacted product, and an additive oil is introduced to an additive oil introduction zone to perform secondary reaction,
the stock oil and the oxygen-containing gas are introduced so that an amount of oxygen in the oxygen-containing gas introduced to the raw material introduction zone is 0.05 to 0.20 Nm³ per 1 kg of the stock oil.

3. An electroconductive material comprising:
the electroconductive carbon black according to claim 1.
